(19) United States
(12) Patent Application Publication
(10) Pub. No.: US 2023/0344510 A1
(43) Pub. Date: Oct. 26, 2023

(54) CONTROLLED CONTENT DELIVERY AT A MOBILE STATION IN A BROADBAND COMMUNICATION SYSTEM

(71) Applicant: SOLANA TECHNOLOGIES, INC., VISTA, CA (US)

(72) Inventors: Kenneth Stanwood, Vista, CA (US); David Gell, San Diego, CA (US)

(73) Assignee: SOLANA TECHNOLOGIES INC., VISTA, CA (US)

(21) Appl. No.: 17/800,969

(22) PCT Filed: Apr. 30, 2021
(86) PCT No.: PCT/US2021/030160

§ 371 Date: Aug. 19, 2022

Related U.S. Application Data
(60) Provisional application No. 63/021,032, filed on May 6, 2020.

(51) Int. Cl. H04B 7/185

(52) U.S. Cl. CPC H04B 7/18519; H04B 7/18541

(57) ABSTRACT

A mobile station provided in a satellite communication network comprised of multiple orbiting satellites, the mobile station including a communication time period estimator that estimates multiple communication time periods when the mobile station will be capable of communication with at least one satellite in the satellite communication network and that identifies one of the multiple communication time periods as a stable communication time period and another of the multiple communication time periods as an unstable communication time period (704), a video segment requester that determines a number of video segments to receive during the stable communication time period, the determined number of video segments being sufficient for video playback on the mobile station during the stable communication time period and the unstable communication time period (705), a transceiver that requests the determined number of video segments, and receives the determined number of video segments, during the stable communication time period from a content deliver network over a connection between the mobile station and the content delivery network via communication of the mobile station with a satellite in the satellite communication network (707), and a video player that plays the received determined number of video segments over the stable communication time period and the unstable communication time period (708).

### CROSS-REFERENCE TO RELATED APPLICATIONS

This application claims the benefit of priority to U.S. Provisional Patent Application No. 63/021,032 filed on May 6, 2020 and entitled “Controlled Content Delivery At A Mobile Station In A Broadband Communication System.”

### BACKGROUND OF THE INVENTION

### 1. Field of Invention

The inventions herein relate to broadband communications, broadband wireless communications, and broadband communications over satellite. The inventions herein further relate to segmenting data such as streaming video into separate connections, such as TCP or PPP, for transport over these communications systems to provide sufficient video playback at a user device such as a mobile station during unstable communication time periods.

### 2. Description of Related Art

Streaming video transported over communications networks from a content delivery network to a user device, such as a mobile station, is often broken up a priori into segments. For instance, Microsoft video streaming services divide video into 2 second segments while Apple video streaming services divide video into 10 second segments. These are typically available at a number of different resolutions. With newer protocols such as HTTP/2.0, it is desirable to send many segments on a persistent TCP connection. However, as was common with HTTP/1.0 one or more segments may be transported as separate TCP connections so that the sets of segments may be relatively independent of each other in terms of data rate, completeness, routing, etc.

In terrestrial wireless communications such as LTE, packet loss, subsequent retransmission, and the resultant delay is more common than in wired networks. This can be more pronounced in airborne wireless communications networks such as might be provided by constellations of satellites (LEO, VLEO), balloons, planes, etc. The user device may be fixed, portable, or mobile. There may be gaps in coverage for the user device in such wireless communications networks.

In a satellite communications network, there may be time periods during which a handover occurs, such as a handover of a mobile station (MS) to a new satellite, a handover of a satellite to another satellite, and a handover of a satellite to a new ground station. Coverage gaps of data communication can occur during these unstable time periods and also during time periods when the mobile station is not in communication with any satellite. As a result, packet loss can occur during these unstable time periods resulting in negative consequences at the mobile station, such as stalling of video playback, for example.

### SUMMARY OF THE INVENTION

In an aspect, a mobile station is provided in a satellite communication network comprised of multiple orbiting satellites, the mobile station including a communication time period estimator that estimates multiple communication time periods when the mobile station will be capable of communication with at least one satellite in the satellite communication network and that identifies one of the multiple communication time periods as a stable communication time period and another of the multiple communication time periods as an unstable communication time period, a video segment requester that determines a number of video segments to receive during the stable communication time period, the determined number of video segments being sufficient for video playback on the mobile station during the stable communication time period and the unstable communication time period, a transceiver that requests the determined number of video segments, and receives the determined number of video segments, during the stable communication time period from a content delivery network over a connection between the mobile station and the content delivery network via communication of the mobile station with a satellite in the satellite communication network, and a video player that plays the received determined number of video segments over the stable communication time period and the unstable communication time period.

In another aspect, a mobile station is provided in a satellite communication network comprised of multiple orbiting satellites, the mobile station including a communication time period manager that receives, over a current communication between the mobile station and a satellite in the satellite communication network, multiple communication time periods when the mobile station will be capable of communication with at least one satellite in the satellite communication network, wherein one of the multiple communication time periods is identified as a stable communication time period and one other of the multiple communication time periods is identified as an unstable communication time period, a video segment requester that determines a number of video segments to receive during the stable communication time period, the determined number of video segments being sufficient for video playback on the mobile station during the stable communication time period and the unstable communication time period, a transceiver that requests the determined number of video segments, and receives the determined number of video segments, during the stable communication time period from a content delivery network over a connection between the mobile station and the content delivery network via communication of the mobile station with a satellite in the satellite communication network, and a video player that plays the received determined number of video segments over the stable communication time period and the unstable communication time period.

In an aspect, a method is provided for video playback on a mobile station provided in a satellite communication network comprised of multiple orbiting satellites, the method including estimating multiple communication time periods when the mobile station will be capable of communication with at least one satellite in the satellite communication network and identifying one of the multiple communication time periods as a stable communication time period and another of the multiple communication time periods as an unstable communication time period, determining a number of video segments to receive during the stable communication time period, the determined number of video segments being sufficient for video playback on the mobile station during the stable communication time period and the unstable communication time period, requesting the determined number of video segments during the stable communication time period from a content delivery network over a connection between the mobile station and the content delivery network via communication of the mobile station with a satellite in the satellite communication network, receiving, via the connection between the mobile station and the content delivery network, the determined number of video segments, and playing, in a video player in the mobile station, the received determined number of video segments over the stable communication time period and the unstable communication time period.

In another aspect, a method is provided for video playback on a mobile station provided in a satellite communication network comprised of multiple orbiting satellites, the method including receiving, over a current communication between the mobile station and a satellite in the satellite communication network, multiple communication time periods when the mobile station will be capable of communication with at least one satellite in the satellite communication network, wherein one of the multiple communication time periods is identified as a stable communication time period and one other of the multiple communication time periods is identified as an unstable communication time period, determining a number of video segments to receive during the stable communication time period, the determined number of video segments being sufficient for video playback on the mobile station over the stable communication time period and the unstable communication time period, requesting the determined number of video segments during the stable communication time period from a content delivery network over a connection between the mobile station and the content delivery network via communication of the mobile station with a satellite in the satellite communication network, receiving the determined number of video segments during the stable communication time period from the content delivery network over the connection between the mobile station and the content delivery network, and playing, on a video player in the mobile station, the received determined number of video segments over the stable communication time period and the unstable communication time period.

The foregoing aspects, and other features and advantages of the invention, will be apparent from the following, more particular description of exemplary aspects of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a top-level system diagram of a mobile station in a satellite communication network according to aspects of the invention;

FIG. 2 is a system diagram depicting various communications of satellites, ground stations and a mobile station in a satellite communication network according to aspects of the invention;

FIG. 3 is a system diagram showing coverage areas of satellites and ground stations in a satellite communication network according to aspects of the invention;

FIG. 4 is a diagram depicting a constellation of low earth orbit (LEO) satellites in a satellite communication network according to aspects of the invention;

FIG. 5 is a timing diagram illustrating various upcoming communication time periods for a mobile station in a satellite communication network according to aspects of the invention;

FIG. 6 is a functional block diagram depicting various functional blocks of a mobile station in a satellite communication network according to aspects of the invention;

FIG. 7 is a flowchart that illustrates a process performed by a mobile station for controlling delivery of video streaming to the mobile station in a satellite communication network according to aspects of the invention;

FIG. 8A is a flowchart that illustrates the estimation of satellite orbit positions and paths at a mobile station according to aspects of the invention;

FIG. 8B is a flowchart that illustrates the obtainment of satellite orbit positions and paths at a mobile station according to aspects of the invention;

FIG. 9 is a flowchart that illustrates the estimation of signal quality values at a mobile station according to aspects of the invention;

FIG. 10 is a flowchart that illustrates the estimation of stable and unstable communication time periods at a mobile station according to aspects of the invention;

FIG. 11 is a flowchart that illustrates the determination of at least one video segment request at a mobile station according to aspects of the invention;

FIG. 12 is a flowchart that illustrates an alternative process performed by a mobile station for controlling delivery of video streaming to the mobile station in a satellite communication network according to aspects of the invention;

FIG. 13A is a block diagram that depicts functional components of a base station of a broadband communication network according to aspects of the invention; and

FIG. 13B is a block diagram that depicts functional components of a mobile station of a broadband communication network according to aspects of the invention.

### DETAILED DESCRIPTION

Aspects of the present invention and their advantages may be understood by referring to the figures, wherein like reference numerals refer to like elements. The descriptions and features disclosed herein can be applied to various devices, systems, software, and methods in broadband communication systems.

The present invention provides a mobile station that receives video segments in a controlled manner within a satellite communication network by determining upcoming stable and unstable time communication periods based on estimated satellite paths and a predicted mobile station path, determining at least one video segment request for an upcoming stable communication time period that includes a determined number of video segments sufficient for video playback on the mobile station during the stable communication time period and at least one subsequent unstable communication time period, receiving the determined number of video segments during the stable communication time period and playing back the determined number of video segments at the mobile station during the stable communication time period and the at least one subsequent unstable communication time period.

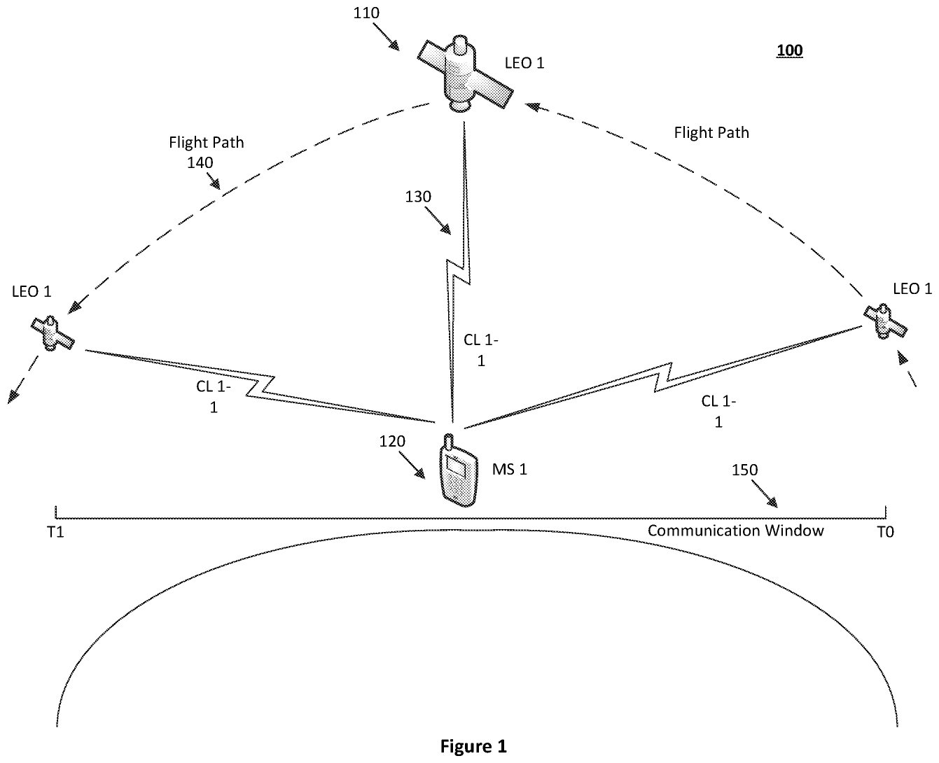

FIG. 1 shows a simplified view of a mobile station MS1 120 communicating with a low earth orbit satellite LEO1 110 via communications link CL1-1 130. As seen in FIG. 1, LEO1 110 moves along flight path 140 of its low earth orbit.

When the satellite LEO1 110 comes within communication range, from the point of view of mobile station MS1 120, at time T0, the two may communicate via communications link CL1-1 130. This communication may continue until the satellite leaves communication range, from the point of view of mobile station MS1 120, at time T1. At or after time T1, mobile station MS1 120 will no longer be able to communicate with satellite LEO1 110. The duration of time that the two may be able to communicate (i.e., T1-T0) is a function of the orbit of satellite LEO1 110 and the time it is in view for MS1 120. For instance, T1-T0 may be somewhere between 1 and 5 minutes for low earth orbit satellites.

The duration of time that the two may be able to communicate (i.e., T1-T0) is also a function of their transmit power, receive sensitivity, phase error, modulation choice, frequency channel, design quality, antenna structure, the weather, interference present, and a myriad of other factors known to one skilled in the art. The duration of time that the two may be able to communicate may, for instance, be prolonged by using beamforming and beam tracking/steering at either or both of mobile station MS1 120 and satellite LEO1 110 instead of omnidirectional or wide-beam antennas. As is known to one skilled in the art, satellite LEO1 110 may utilize one or more transmitted spot beams, each of which provide a fraction of LEO1 110's total coverage area.

In a broadband communication system providing continuous communication capability for real-time services such as voice, it may be preferable that mobile station MS1 120 would handoff (or synonymously handover) to another satellite before losing communications with satellite LEO1 110. For other services where data may be buffered, such as streaming video, controlled gaps in coverage and gaps in service during handover events may be tolerated and may even be preferred for power savings purposes.

Therefore, the time that mobile station MS1 120 and satellite LEO1 110 are capable of communicating with each other may be longer than the time that they actually do communicate with each other. The time that they actually do communicate may be a shorter duration and may be affected by, for instance, MS1 120 handing over to another satellite before time T1 or from another satellite after time T0.

While a low earth orbit (LEO) satellite is used as an example, one skilled in the art would understand that the inventions described herein may be applied to a broadband communication system utilizing very low earth orbit satellites (VLEO), balloons, airplanes or any other broadband communication system where such a vehicle with the equivalent of a GSM base transceiver station BTS function, WiMAX base station, UMTS NodeB, LTE evolved NodeB (eNodeB or eNB) or similar base station function is utilized. In such communication systems, the vehicle acting as the base station and the mobile station may move relatively fast and predictably with respect to each other geographically.

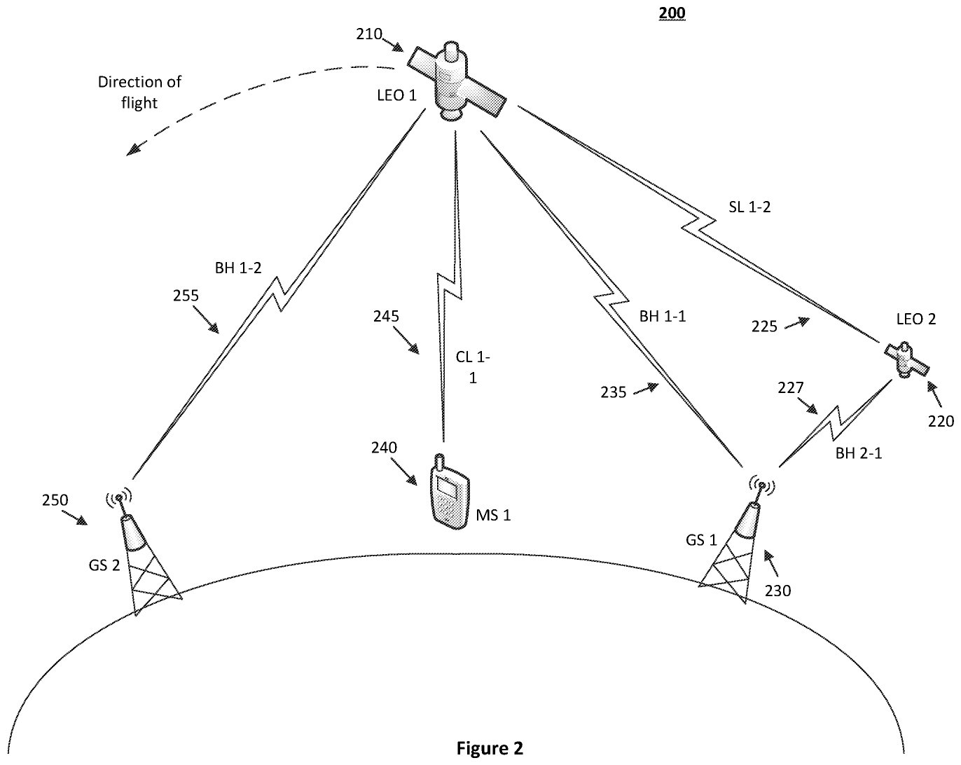

FIG. 2 shows a more detailed system view 200 of a mobile station MS1 240 communicating with a satellite LEO1 210 via communications link CL1-1 245.

As seen in FIG. 2, satellite LEO1 210 communicates with mobile station MS1 240 via communication link CL1-1 245. In an aspect, communication link CL1-1 245 comprises an uplink portion for transmitting data from mobile station MS1 240 to satellite LEO1 210 and a downlink portion for transmitting data from satellite LEO1 210 to mobile station MS1 240.

In an aspect, LEO1 210 provides the equivalent of a base transceiver station function, base station, eNodeB access point, or similar function as would be known to one skilled the art of broadband communication systems such as UMTS, LTE, WiMAX, WiFi, etc. Satellite LEO1 210 communicates with one or more ground stations GS1 230 and GS2 250 over backhauls BH1-1 235 and BH1-2 255, respectively. Backhauls, such as BH1-1 235 and BH1-2 255, preferably have an uplink portion for transmitting to a satellite and a downlink portion for receiving from a satellite. Satellite LEO1 210 may handover, or synonymously handoff, from one ground station to another, e.g., from ground station GS1 230 to ground station GS2 250, as needed based on the geographic placement of the ground stations relative to the path of flight of satellite LEO1 210.

In a constellation of satellites, as satellite LEO1 210 leaves the view of mobile station MS1 240, one or more other satellites, such as satellite LEO2 220, preferably come into view of mobile station MS1 240. Satellite LEO2 220 will preferably have established communications with one or more ground stations such as ground station GS1 230 over backhaul BH2-1 227. In an aspect, satellites LEO1 210 and LEO2 220 communicate over a two-way communication sidelink SL1-2 225 which may be a point-to-point link operated as part of a mesh network between the constellation of satellites or other type of satellite-to-satellite (inter-satellite) communication network as would be known to one skilled the art. In an aspect, sidelink SL1-2 225 may provide communications protocols including the equivalent of the LTE X2 interface or the WiMAX R8 interface. Due to relative motion of the satellites, satellite LEO1 210 may handover to a different sidelink for communication with a different satellite than LEO2 220.

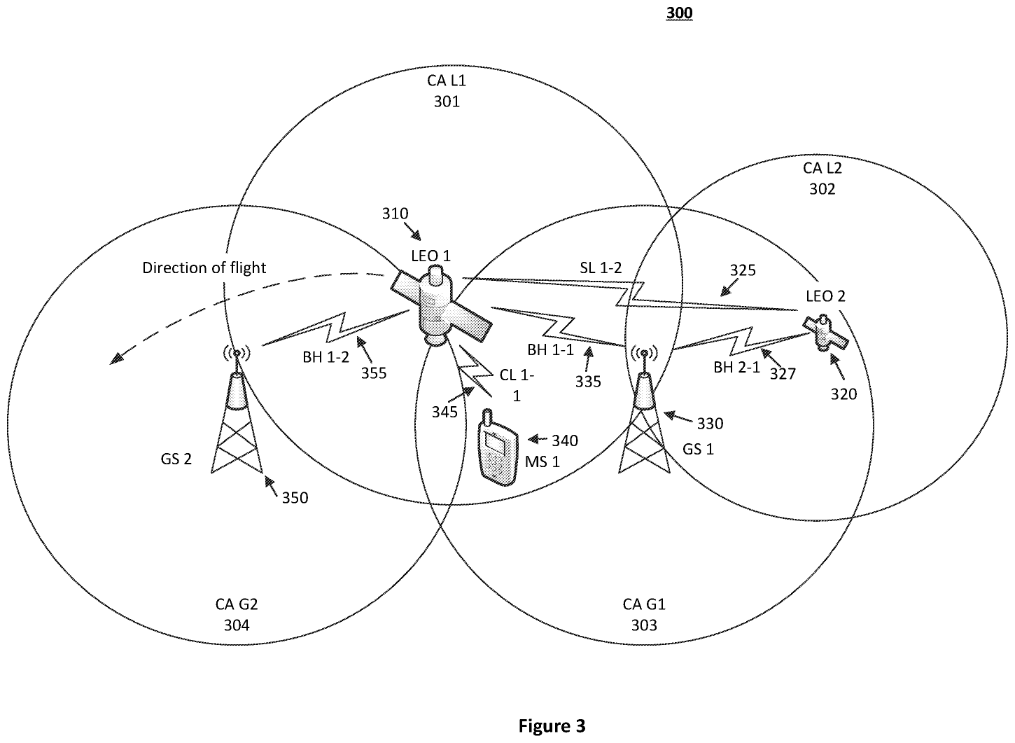

FIG. 3 shows an example of the communication system of FIG. 2 when viewed from above.

As seen in system view 300 of FIG. 3, ground stations GS1 330 and GS2 350 have coverage areas CAG1 303 and CAG2 304, respectively. In an aspect, these coverage areas overlap so satellites passing from one coverage area to the next may hand over from one ground station to the next.

Similarly, satellites LEO1 310 and LEO2 320 have coverage areas CAL1 301 and CAL2 302, respectively. In an aspect, these coverage areas overlap so mobile stations, such as mobile station MS1 340, may hand over from one satellite to the next as the satellite passes overhead. Note that the above examples are described using only a single mobile station. However, one skilled the art would understand that a satellite may be in communication with one or more mobile stations at any given point in time.

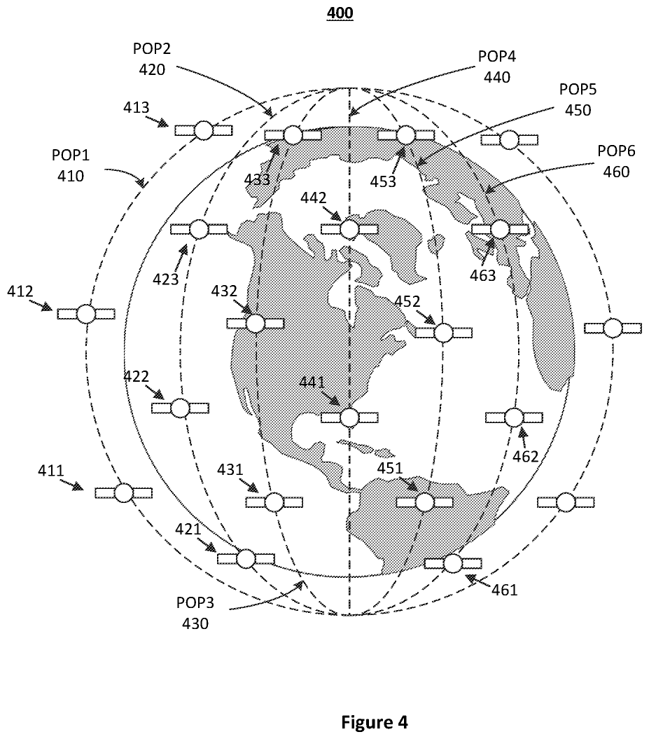

FIG. 4 depicts a satellite constellation system 400 and shows a picture of the earth with an example of a satellite constellation comprising six polar orbits, according to an aspect of the invention. As seen in FIG. 4, a number of satellites each follow one of the polar orbit paths, labeled POP1 410 through POP6 460. For example, satellites 411, 412 and 413 follow along POP1 410, satellites 421, 422 and 423 follow along POP2 420, etc. Polar orbits are shown for example only. Other orbital inclinations are well known in the art and could be used. Six orbits are shown for example only. Other numbers of orbits are well known in existing and planned satellite constellations and could be used. This depicted constellation of FIG. 4 is useful for describing scenarios that may arise in satellite communications.

Note that some satellites may spend significant time above very large bodies of water, such as the Pacific Ocean. Other satellites may spend significant time over large countries with whom the satellite system operator does not have an agreement to place ground stations. In either case, there may be no suitable place for a ground station to communicate with the satellite in such a situation. With reference to FIG. 3 above, as satellite LEO1 310 leaves the coverage area of ground station GS1 330, there may be no ground station GS2 350 to which it may handover. In this case, satellite LEO2 320 may act as a relay. In this situation, satellite LEO1 310 transmits data received from mobile station MS1 340 on sidelink SL1-2 325 to satellite LEO2 320. Satellite LEO2 320 forwards that data to ground station GS2 350 on behalf of satellite LEO1 310. Similarly, data bound for mobile station MS1 340 may be transmitted by ground station GS1 330 to satellite LEO2 320 which forwards the data to satellite LEO1 310 on sidelink SL1-2 325 for transmission to mobile station MS1 340 on communication link CL1-1 345. Satellites LEO1 310 and LEO2 320 may be on the same orbital path or on adjacent orbital paths. In other aspects, they may be on overlapping orbital paths.

As seen in FIG. 4 there may be substantial overlap of the polar orbit paths POP1 410 through POP6 460 at the poles. This may cause the coverage areas of two or more satellites to substantially overlap simultaneously. Too many satellites operating in the same space at the same time can cause interference. This is aggravated by constellations with more satellites and more polar orbits. It can be alleviated by having some satellites temporarily turn off some or all channels on some or all of their spot beams or other transmission modules. Additionally, some countries disallow certain satellite transmissions while the satellites are passing over their territory. This can be addressed by having the satellite not transmit while transiting over these countries. Both cases cause coverage gaps in the timeline of visibility of that particular satellite. That is to say, there may be times when it is technically possible for the satellite to communicate with a mobile station or ground station, but it does not due to an intentional outage of coverage.

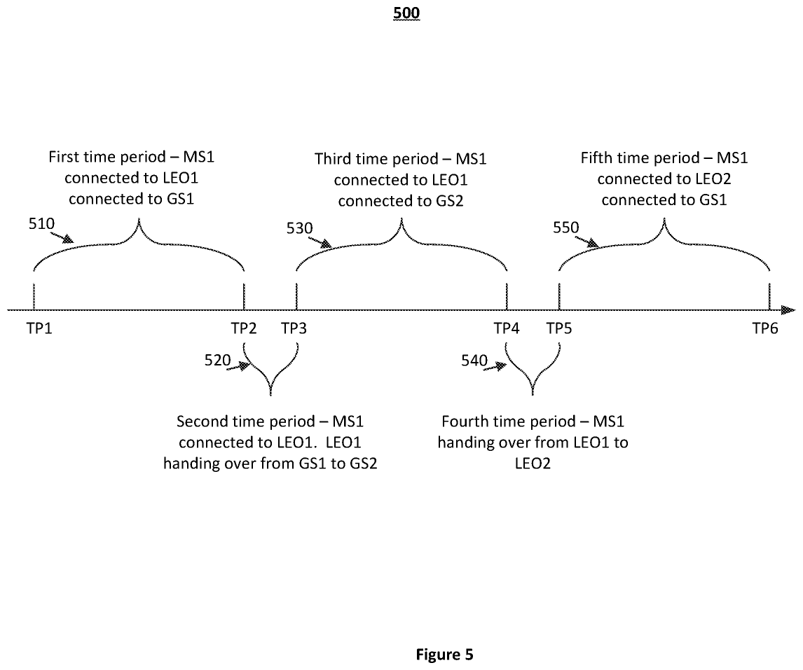

With reference to FIG. 5, due to satellite LEO1 handing over from ground station GS1 to ground station GS2 there may be a first communication time period 510 when mobile station MS1 is connected to satellite LEO1 and satellite LEO1 is connected with ground station GS1, a second communication time period 520 when mobile station MS1 is connected to satellite LEO1 and satellite LEO1 is connected with both ground stations GS1 and GS2 for the purposes of LEO 1 handing over from one ground station to the other. There may be a third communication time period 530 when mobile station MS1 is connected to satellite LEO1 and satellite LEO1 is connected with ground station GS2. There may be a fourth communication time period 540 when mobile station MS1 is connected to both satellite LEO1 and satellite LEO2 for the purposes of mobile station MS1 handing over between satellites, and satellite LEO1 is connected with ground station GS2 and satellite LEO2 is connected with ground station GS1. There may be a fifth communication time period 550 when mobile station MS1 is connected to satellite LEO2 and satellite LEO2 is connected with ground station GS1.

As seen in FIG. 5, the first communication time period 510 starts at time TP1 and ends at time TP2. The second communication time period 520 starts at time TP2 and ends at time TP3. The third communication time period 530 starts at time TP3 and ends at time TP4. The fourth communication time period 540 starts at time TP4 and ends at time TP5. The fifth communication time period 550 starts at time TP5 and ends at time TP6. These and similar communication time periods recur, from the point of view of mobile station MS1 as satellites transition out of view and different satellites transition into view. Communication time periods such as the first communication time period 510, the third communication time period 530, and the fifth communication time period 550 when neither the satellite is handing over to a new ground station nor the mobile station is handing over to a new satellite represent communication time periods which are, from the point of view of the mobile station and its connections, stable communication time periods. Communication time periods such as the second communication time period 520 and the fourth communication time period 540, where one or the other of the satellite or the mobile station is involved in a handover, may be, from the point of view of the mobile station and its TCP connections, unstable communication time periods. For instance, the instability of these communication time periods may cause a TCP connection to break due to needed changes in routing parameters such as IP address, gaps in coverage or excessive lost packets.

Note that, while in FIG. 5 some communication time periods, such as the first communication time period 510 and the third communication time period 530, are shown as the same length visually, this only as an example. For instance, if mobile station MS1 were a shorter distance to ground station GS1 than to ground station GS2, the first communication time period 510 would be longer in duration than the third communication time period 530. In fact, the second communication time period 520 and the third communication time period 530 may not exist, depending upon the topology.

With respect to the duration of time mobile station MS1 and satellite LEO1 may be able to communicate as was shown in FIG. 1, time T0 would occur sometime prior to time TP1 and time T1 would occur after time TP4.

To better ensure lossless delivery of streaming video segments to mobile client MS1, a satellite orbit estimator in mobile station MS1 predicts how long each of the communication time periods will be based on knowledge of the orbits of satellites LEO1, LEO2, and other satellites in the constellation, the position of ground stations, GS1, GS2, and other ground stations in the satellite system, and the current position and velocity of mobile station MS1. This information may be downloaded to mobile station MS1, accessed over the satellite communication system via communication link CL1-1, or determined observationally. Known methods and techniques for predicting satellite orbit paths and mobile station paths can be utilized herein in the determination of communication time periods related to mobile station MS1.

Based on the predicted communication time periods, a video segment selector in mobile station MS1 determines the attributes of the video segments to request from the video server. The number and representation quality of video segments, and therefore the duration of the TCP connection(s), is determined to best avoid breaking the connection(s) (such as a TCP or PPP connection, for example) due to handover of mobile station MS1 between satellites or due to handover of a satellite, for instance satellite LEO1, between two ground stations. For instance, the set of video segments requested for delivery during the first time period may have a duration approximately equal to the sum of the duration the first communication time period 510 and the second communication time period 520 to avoid duplicate segment requests and possible video playback disruption due to the potential for breaking the connection(s) during handover of satellite LEO1 from ground station GS1 to ground station GS2. Similarly, the set of video segments requested for delivery during the third communication time period 530 may have a duration approximately equal to the sum of the duration the third communication time period 530 and the fourth communication time period 540 to avoid duplicate segment requests and possible video playback disruption due to the potential for breaking the connection(s) during handover of mobile station MS1 from satellite LEO1 to satellite LEO2.

However, if the third communication time period 530 is predicted to have a short duration relative to the first communication time period 510, for instance if mobile station MS1 is much closer to ground station GS 1, the set of video segments requested for delivery during the first communication time period 510 may have a duration approximately equal to the sum of the duration of the first communication time period 510, the second communication time period 520, the third communication time period 530, and the fourth communication time period 540.

There may be gaps in coverage for MS1. For instance, satellite LEO1 may pass out of view of mobile station MS1 prior to satellite LEO2 coming into view. In this case, the fourth communication time period 540 represents a coverage gap. The set of video segments requested for delivery prior to the fourth communication time period 540 may include a sufficient number of segments to keep the video from stalling during the coverage gap.

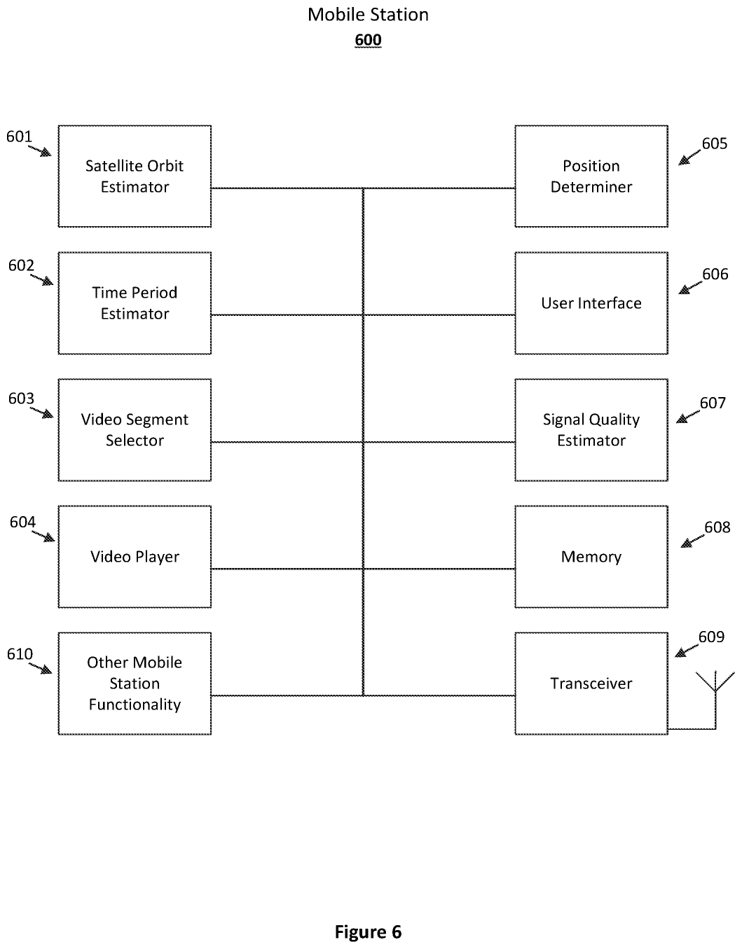

FIG. 6 is a functional block diagram that shows the functionality of mobile station 600 according to aspects of the invention. Mobile station 600 may represent, for example, mobile station MS1 shown in previous figures. The functional blocks depicted in FIG. 6 may all communicate and interact with each other by sharing data and/or by sending commands or control signal to each other.

Turning now to FIG. 6, Position Determiner 605 determines the position of the mobile station 600. In an embodiment, Position Determiner 605 may be via a satellite positioning system such as, for example, the global positioning system (GPS). It may utilize inertial navigation. Mobile station 600 may accept location coordinates from ground navigation systems or may accept location coordinates from a vehicle in which it resides or of which it is a part, such an airplane, train, or automobile. Other known methods and techniques for determining a position of a mobile station may be utilized for Position Determiner 605.

Position determiner 605, may also calculate an expected path of mobile station 600. The expected path could be based upon a preselected destination and path such as from a flight plan or choosing a destination in a map program such as Google Maps. The expected path could be learned such as learning that the owner of the mobile station typically goes to a work location or a home location at approximately the time of day of the calculation.

Position determiner 605 may also determine an expected possible area for mobile station 600 over some period of time, for instance 30 minutes. This expected possible area could be based on possible speeds, whether the mobile station is terrestrial and restricted to roads or airborne and not restricted to roads. The expected area may be further overlaid with a probability based on historical data, terrain, etc.

If mobile station 600 is not mobile, but fixed, position determiner 605 may determine position, expected path, and expected possible area from the address or input coordinates.

Satellite Orbit Estimator 601 determines the paths of satellites relative to mobile station 600. It may do so for all satellites in a constellation or for only a subset. The subset may be only for those satellites with a high likelihood of being visible to mobile station 600 within a certain time period, for instance 30 minutes. For example, paths may be calculated for satellites on orbital paths, determined or expected to be within a certain distance of the position, expected path, or expected possible area of mobile station 600, within a certain time period, as determined by position determiner 605.

Signal Quality Estimator 607 estimates the signal quality with which the mobile station 600 may be able to communicate with one or more satellites during the course of their paths estimated by the satellite orbit estimator 601 and passed upon the position, expected path, or expected possible area of mobile station 600.

Time Period Estimator 602 calculates the time periods of expected stability and possible instability of communication between mobile station 600 and the satellites, including communication gaps, and communication time periods of expected stability and possible instability of communication between satellites and ground stations as described above with reference to FIG. 5.

Video Segment Selector 603 selects groups of video segments to be received during stable communication time periods determined by time period estimator 602. In an embodiment, a group of video segments is comprised of few enough video segments to be received during a stable communication time period while representing enough viewing time duration so as not to have the video playback stall during subsequent unstable communication time periods. In an aspect, each group of selected video segments is transmitted as an independent connection, such as a TCP connection. The video quality and the chosen video representation may be affected by the estimated signal quality and available or assigned communication bandwidth during the stable communication time period.

Video Player 604 buffers video segments for playback to the user. It calculates a video buffer occupancy which is the number of seconds of video that is currently buffered. If no more video segments are received before this number of seconds elapses, all previously received video segments will have been played and the video will stall. It is preferable that the video segment selector 603 requests groups of video segments at a rate sufficient to avoid video playback stalls, in particular by watching for unstable communication time periods.

User Interface 606 provides the typical user interface of a user device, including the display of video, user input, audio output, other known user interface devices, etc.

Memory 608 provides memory for mobile station 600 to buffer video, store data and parameters, and store executable software and/or firmware code such as programs, applications, and operating systems.

Transceiver 609 provides communication functionality between the mobile station 600 and the satellites in the satellite communication network. Known hardware, software, algorithms, techniques, and methods may be utilized to implement the functionality of transceiver 609. Transceiver 609 measures attributes of signals such as receive signal strength, phase error, SNR, CINR, SINR, and other attributes that may impact the quality and bandwidth of communications between mobile station 600 and the satellites.

Other Mobile Station Functionality 610 contains other known types of functionality that may be necessary or optional for use in mobile station 600.

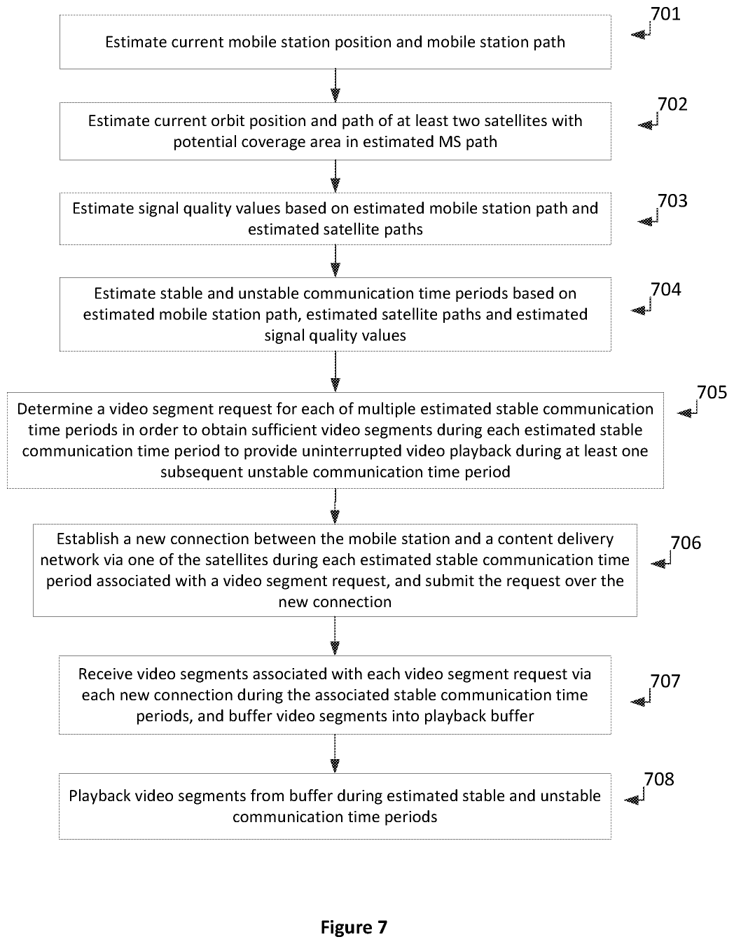

FIG. 7 is a flowchart that illustrates a process performed by a mobile station for controlling delivery of video streaming to the mobile station in a satellite communication network according to aspects of the invention. In step 701, the mobile station (such as mobile station MS1 in previous figures) estimates its own position and an expected mobile station path and may also estimate an expected location area. The mobile station estimates its position, expected mobile station path and expected location area according to the description provided above for Position Determiner 605 of FIG. 6.

In step 702, the mobile station estimates the current orbit position and path of two or more satellites in a satellite communication network that are expected to have potential coverage area overlapping or intersecting with the estimated mobile station path or location area. In this regard, the mobile station estimates the current orbit position and path of two or more satellites according to the description provided above for Satellite Orbit Estimator 601 of FIG. 6.

Next, in step 703, the mobile station estimates upcoming signal quality values based on the estimated mobile station path and the estimated satellite paths. The mobile station estimates the signal quality values according to the description provided above for Signal Quality Estimator 607 of FIG. 6.

The process then proceeds to step 704 in which the mobile station estimates stable and unstable communication time periods based on the estimated mobile station path, the estimated satellite paths, and the estimated signal quality values. The mobile station estimates the stable and unstable communication time periods according to the description provided above for Time Period Estimator 602 of FIG. 6.

In step 705, the mobile station determines a video segment request for each of multiple estimated stable communication time periods in order to obtain sufficient video segments during each estimated stable communication time period to provide uninterrupted video playback during at least one subsequent unstable communication time period. The mobile station determines the video segment request(s) according to the description provided above for Video Segment Selector 603 of FIG. 6.

Process flow then proceeds to step 706 in which the mobile station establishes a new connection between the mobile station and a content delivery network via one of the satellites during each estimated stable communication time period associated with a video segment request and submits the request over the new connection. For example, the mobile station establishes a new TCP connection between the mobile station and a content delivery network for streaming video delivery, wherein the TCP connection is conducted through communication of the mobile station with a servicing satellite during the associated stable communication time period. The TCP connection is torn down after completion of the specific video segment request, and a new TCP connection must be established for each subsequent video segment request.

In step 707, the mobile station receives video segments associated with each video segment request via each new associated connection during the associated stable communication time periods and buffers the received video segments into a playback buffer. The mobile station conducts the video buffering according to the description provided above for Video Player 604 of FIG. 6.

Next, in step 708 the mobile station plays back the received video segments from the buffer during the associated estimated stable and unstable communication time periods, thereby providing continuous video playback even during unstable communication time periods when the mobile station is not actually receiving video segments. The mobile station conducts the video playback according to the description provided above for Video Player 604 of FIG. 6.

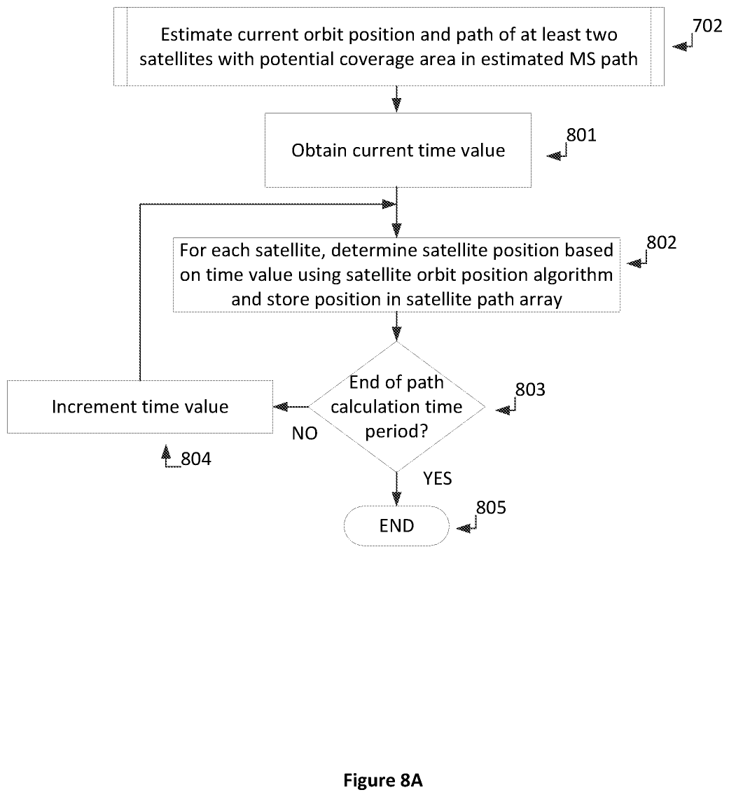

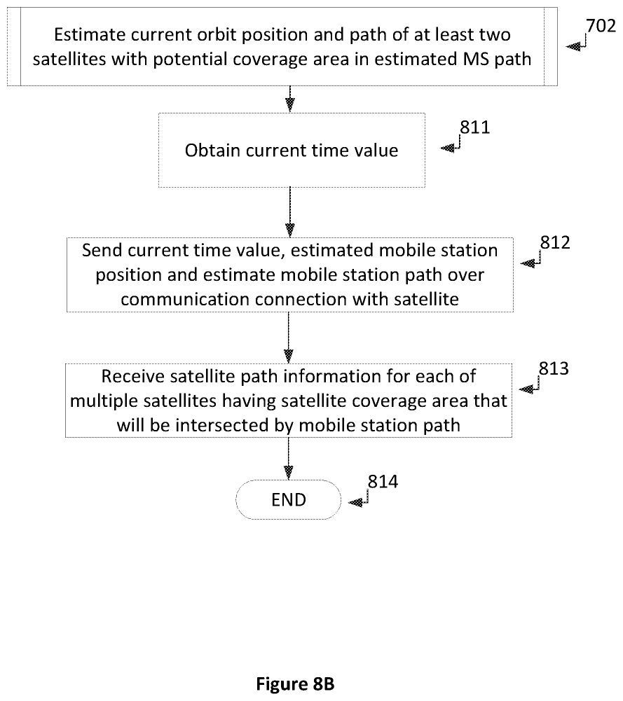

FIG. 8A is a flowchart that illustrates the estimation of orbit positions and paths of at least two satellites with potential coverage area in the estimated mobile station path according to aspects of the invention, such as step 702 of FIG. 7. The mobile station can conduct the estimation of satellite orbit positions and paths according to the description provided above for Satellite Orbit Estimator 601 of FIG. 6. In step 801, a current time value is obtained, such as for example from a GSM service or from communication with a satellite, or other known method. Next, in step 802, a satellite position is determined for the time value based on a satellite orbit position algorithm and then the determined satellite position is stored in association with the time value in a satellite path array or table which can be stored in memory 608 for example. The satellite orbit position algorithm may be based on a known satellite orbit equation such as:

$$Mean motion n = \frac{2 π}{ρ} , where P is the orbital period . \qquad Equation 1$$

In another aspect, the satellite orbit position algorithm may be a software code or a chart in which the predetermined orbit path of each satellite is provided. For example, the operator of a satellite communication network may provide such software code or chart for preloading or convenient access by a mobile station in the satellite communication network. Such code or chart may be stored in memory 608 of the mobile station, for example.

In step 803, it is determined if the end of the calculation time period has been reached, wherein the calculation time period is a predetermined amount of time for which to estimate the satellite path, such as for example the upcoming 30 minutes. If it is the end of the calculation time period, the process flow proceeds to the end of the process in step 805, upon which the estimation of the path for each satellite of interest has been completed.

If it is not the end of the calculation time period, the process flow proceeds to step 804 in which the time value is incremented by a fixed amount (the next incremental step in the estimated satellite path) and the process flow reverts back to step 802 to determine the next incremental position in the satellite path for each satellite of interest.

FIG. 8B is a flowchart that illustrates the obtainment of orbit positions and paths of at least two satellites with potential coverage area in the estimated mobile station path according to other aspects of the invention, such as step 702 of FIG. 7. The mobile station can conduct the estimation of satellite orbit positions and paths according to the description provided above for Satellite Orbit Estimator 601 of FIG. 6. In step 811, a current time value is obtained, such as for example from a GSM service or from communication with a satellite, or other known method. Next, in step 812, the mobile station sends the time value, the estimated mobile station position and the estimated mobile station path via the communication connection with the currently servicing satellite. In step 813, the mobile station receives satellite position and path information for each of multiple satellites having satellite coverage area that will be intersected by the estimated mobile station path. The process then ends at step 814. For example, in this manner the mobile station may use a realtime service operated by the operator of the satellite communication network to quickly obtain upcoming satellite positions and paths of nearby satellites that the mobile station is likely to be in the coverage area of In the alternative, the upcoming satellite positions and paths may be calculated for the mobile station by the servicing satellite, or by a ground station which is in communication with the servicing satellite and then sent to the mobile station.

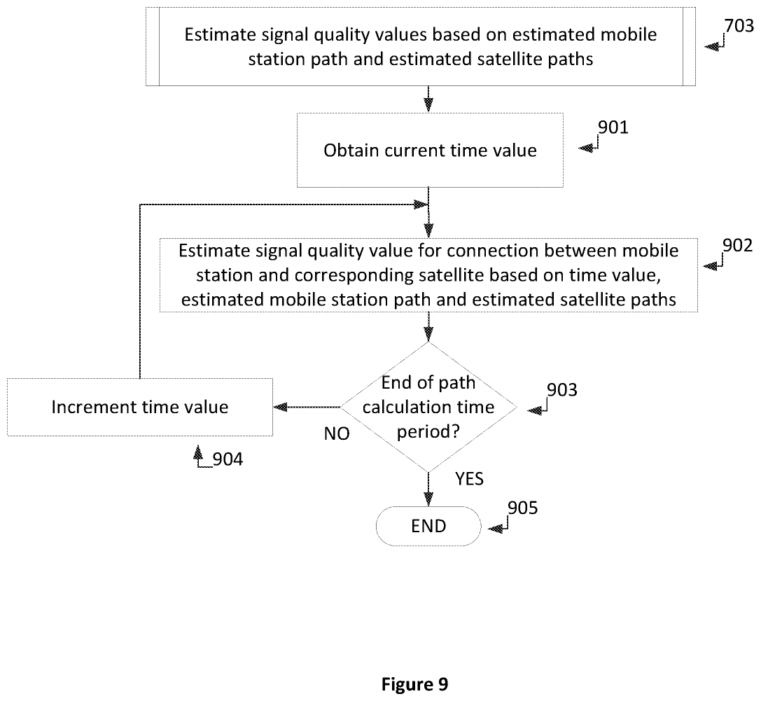

FIG. 9 is a flowchart that illustrates the estimation of signal quality values at a mobile station according to aspects of the invention, such as step 703 of FIG. 7. The mobile station can estimate the signal quality values according to the description provided above for Signal Quality Estimator 607 of FIG. 6. In step 901, a current time value is obtained, such as for example from a GSM service or from communication with a satellite, or other known method. Next, in step 902, a signal quality value is estimated for the communication connection between mobile station and the corresponding satellite based on the time value, the estimated mobile station path and the estimated satellite paths. The signal quality value may also be based on past signal quality values measured by the transceiver of the mobile station when communicating with the particular satellite of interest.

In step 903, it is determined if the end of the calculation time period has been reached, wherein the calculation time period is a predetermined amount of time for which to estimate the signal quality values, such as for example the upcoming 30 minutes. If it is the end of the calculation time period, the process flow proceeds to the end of the process in step 905, upon which the estimation of the signal quality values for the calculation time period has been completed.

If it is not the end of the calculation time period, the process flow proceeds to step 904 in which the time value is incremented by a fixed amount (the next incremental step in the estimated satellite path) and the process flow reverts back to step 902 to determine the next signal quality value for each satellite of interest at that incremented time value.

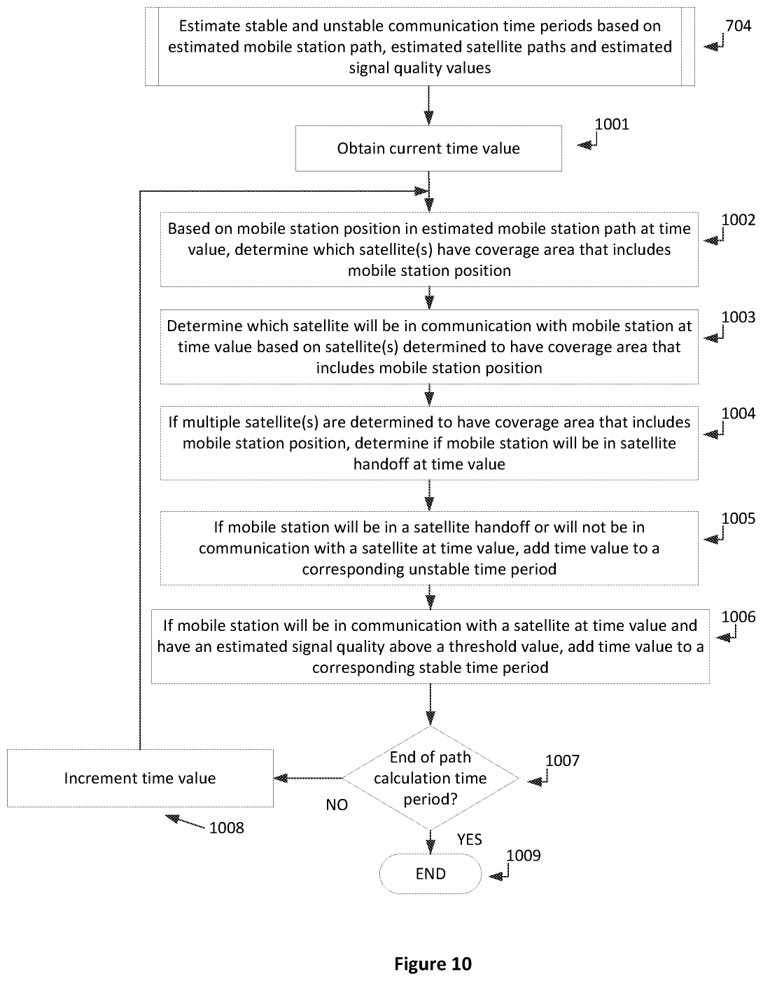

FIG. 10 is a flowchart that illustrates the estimation of stable and unstable communication time periods at a mobile station according to aspects of the invention, such as step 704 of FIG. 7. The mobile station can estimate the stable and unstable communication time periods according to the description provided above for Time Period Estimator 602 of FIG. 6. In step 1001, a current time value is obtained, such as for example from a GSM service or from communication with a satellite, or other known method.

Next, in step 1002, the mobile station determines which satellite(s) have coverage area that will include the mobile station position based on the mobile station position and the estimated mobile station path at the time value. In step 1003, the mobile station determines which satellite will be in communication with mobile station at the time value based on those satellite(s) determined (in step 1002) to have a coverage area that includes the mobile station position.

Process flow proceeds to step 1004 in which, for the situation that multiple satellite(s) are determined (in step 1003) to have coverage area that includes the mobile station position, the mobile station determines if it will be in a satellite handoff at the time value. In step 1005, if it is determined in step 1004 that the mobile station will be in a satellite handoff or will not be in communication with a satellite at the time value, the time value is added to a corresponding unstable communication time period.

In step 1006, if it is determined in steps 1003 and 1004 that the mobile station will be in communication with a satellite at the time value and will not be in a satellite handoff at the time value, and the mobile station has an estimated signal quality for that time value above a threshold value, then the time value is added to a corresponding stable communication time period.

In step 1007, it is determined if the end of the calculation time period has been reached, wherein the calculation time period is a predetermined amount of time for which to estimate the stable and unstable communication time periods, such as for example the upcoming 30 minutes. If it is the end of the calculation time period, the process flow proceeds to the end of the process in step 1009, upon which the estimation of the stable and unstable communication time periods for the calculation time period has been completed.

If it is not the end of the calculation time period, the process flow proceeds to step 1008 in which the time value is incremented by a fixed amount (the next incremental step) and the process flow reverts back to step 1002 to repeat steps 1002 through 1006 for the continued estimation of the stable and unstable communication time periods.

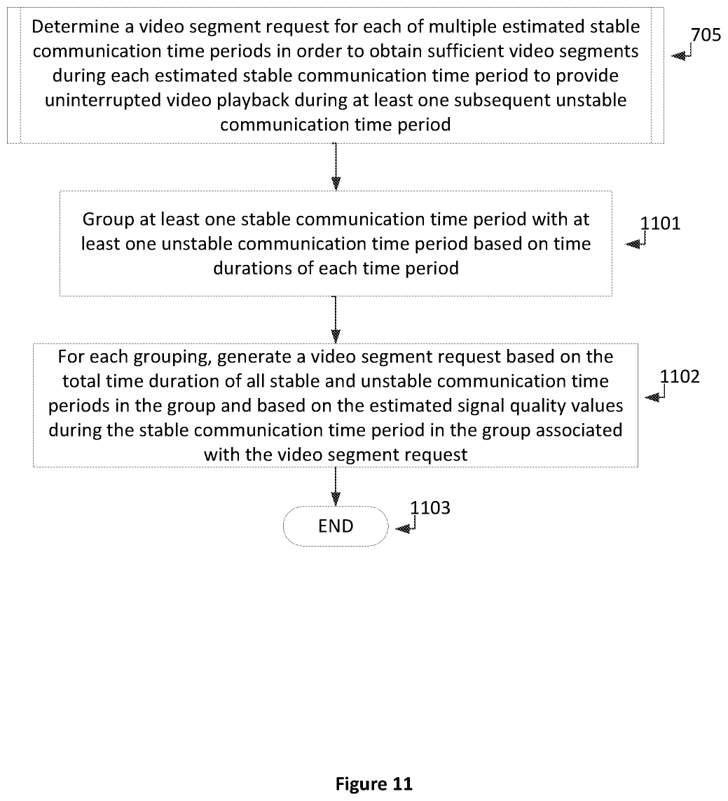

FIG. 11 is a flowchart that illustrates the determination of at least one video segment request at a mobile station according to aspects of the invention, such as step 705 of FIG. 7. The mobile station can determine the at least one video segment request according to the description provided above for Video Segment Selector 603 of FIG. 6. In step 1101, the mobile station groups at least one stable communication time period with at least one unstable communication time period based on time durations of each communication time period. For example, and upcoming stable communication time period may be grouped with only one or with several subsequent upcoming unstable communication time periods, so that sufficient video segments may be received by the mobile station during only the upcoming stable communication time period to maintain video playback also during the associated one or several subsequent unstable communication time periods.

Next, in step 1102, for each group created in step 1101, the mobile station generates a corresponding video segment request based on the total time duration of the stable and unstable communication time periods provided in the group and also based on the estimated signal quality values during the stable communication time period in the group associated with the video segment request. The process flow then ends at step 1103.

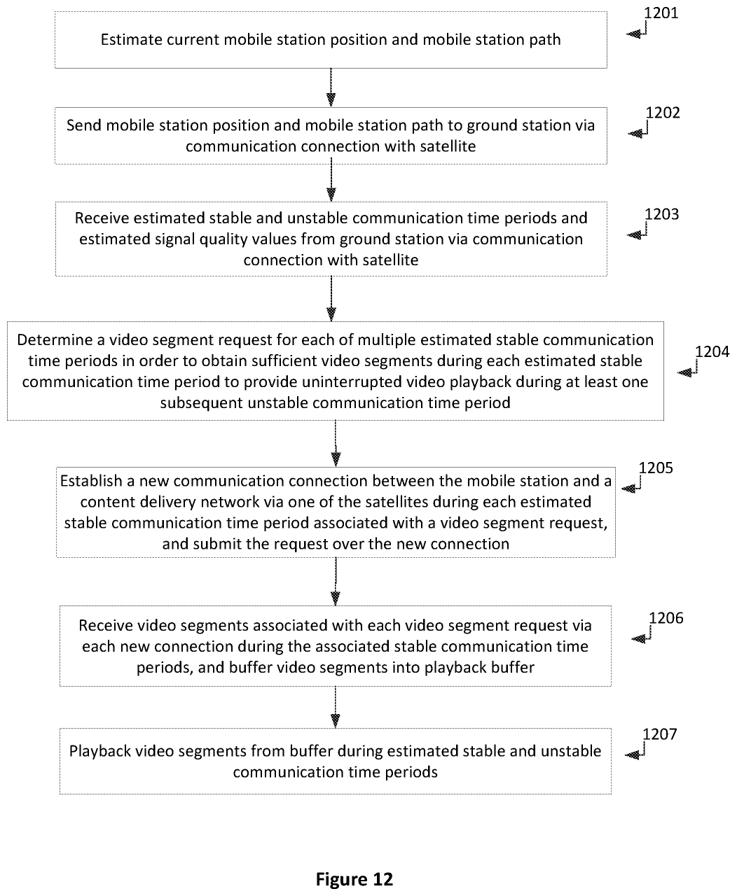

FIG. 12 is a flowchart that illustrates an alternative process performed by a mobile station for controlling delivery of video streaming to the mobile station in a satellite communication network according to aspects of the invention.

In step 1201, the mobile station (such as mobile station MS1 in previous figures) estimates its own position and an expected mobile station path and may also estimate an expected location area. The mobile station estimates its position, expected mobile station path and expected location area according to the description provided above for Position Determiner 605 of FIG. 6.

In step 1202, the mobile station sends the estimated mobile station position and path to a ground station via a communication connection of the mobile station with a satellite. In the alternative, the mobile station sends the estimated mobile station position and path to a third-party service, such as a service offered by the operator of the satellite communication network, via a communication connection of the mobile station with a satellite (and via a ground station in communication with the satellite). This step can be performed by a communication time period manager function, which may for example be provided in Time Period Estimator 602 of FIG. 6.

In step 1203, the mobile station receives estimated stable and unstable communication time periods and estimated signal quality values from the ground station (or from the third-party service) via the communication connection of the mobile station with the satellite. The received estimated stable and unstable communication time periods and estimated signal quality values are stored in memory. This step can also be performed by a communication time period manager function, which may for example be provided in Time Period Estimator 602 of FIG. 6.

In step 1204, the mobile station determines a video segment request for each of multiple estimated stable communication time periods in order to obtain sufficient video segments during each estimated stable communication time period to provide uninterrupted video playback during the stable communication time period and the at least one subsequent unstable communication time period. The mobile station determines the video segment request(s) according to the description provided above for Video Segment Selector 603 of FIG. 6.

Process flow then proceeds to step 1205 in which the mobile station establishes a new connection between the mobile station and a content delivery network via one of the satellites during each estimated stable communication time period associated with a video segment request and submits the request over the new connection. For example, the mobile station establishes a new TCP connection between the mobile station and a content delivery network for streaming video delivery, wherein the TCP connection is conducted through communication of the mobile station with a servicing satellite during the associated stable communication time period. The TCP connection is torn down after completion of the specific video segment request, and a new TCP connection must be established for each subsequent video segment request.

In step 1206, the mobile station receives video segments associated with each video segment request via each new associated connection during the associated stable communication time periods, and then buffers the received video segments into a playback buffer. The mobile station conducts the video segment buffering according to the description provided above for Video Player 604 of FIG. 6.

Next, in step 1207 the mobile station plays back the received video segments from the buffer during the associated estimated stable and unstable communication time periods, thereby providing continuous video playback even during unstable communication time periods when the mobile station is not actually receiving video segments. The mobile station conducts the video playback according to the description provided above for Video Player 604 of FIG. 6.

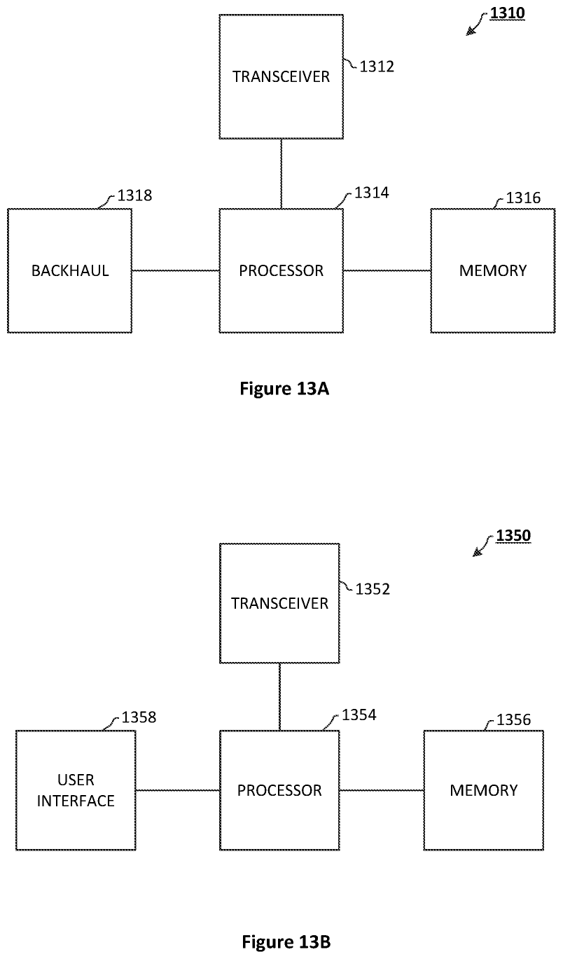

FIG. 13A is a block diagram of a base station 1310 in accordance with aspects of the invention. Base station 1310 may be a GSM base transceiver station BTS function, a WiMAX base station, a UMTS NodeB, an LTE evolved NodeB (eNodeB or eNB), or a similar functional device. In various aspects, the functionality of base station 1310 may be provided in a low earth orbit satellite such as LEO1 in a satellite communication network as shown in the previous figures. Alternatively, base station 1310 may be implemented in very low earth orbit satellites (VLEO), balloons, airplanes or any other broadband communication system implementing such a vehicle with the equivalent of a GSM base transceiver station BTS function, a WiMAX base station, a UMTS NodeB, an LTE evolved NodeB (eNodeB or eNB) or a similar function.

Base station 1310 includes a processor 1314. Processor 1314 is coupled to a transceiver (transmitter-receiver) 1312, a backhaul interface 1318, and a memory storage 1316. The transceiver 1312 is configured to transmit and receive communications wirelessly with other devices. Base station 1310 generally includes one or more antennae, in connection with transceiver 1312, for transmission and reception of radio signals. The communications of the transceiver 1312 may be with user stations, such as mobile station MS1, with other satellites, and with ground stations. Transceiver 1312, in connection with antennae, may generate a communication coverage area such as a moving coverage area on the earth's surface as the satellite containing transceiver 1312 moves along its predetermined orbital path. Transceiver 1312, in connection with antennae, may generate the communication coverage area using beamforming or other known transmission techniques and may generate multiple spot beams to make up the entire communication coverage area.

Backhaul interface 1318 provides an interface between base station 1310 and a core network, such as a core network supporting a satellite communications network. This interface may include communications via transceiver 1312 directly or indirectly with ground stations, and/or with other satellites via an inter-satellite sidelink connection. In this manner, communications received at transceiver 1312 from a mobile station, for example, may then be transmitted by backhaul interface 1318 to a core network back through transceiver 1312 or another transceiver to a ground station or through another satellite to a ground station. Similarly, communication received from the core network to the backhaul interface 1318 may then be transmitted by the transceiver 1312 to a mobile station. Although the base station 1310 of FIG. 13A is shown with a single backhaul interface 1318, other aspects may include multiple backhaul interfaces. Similarly, the base station 1310 may include multiple transceivers, and the multiple interfaces and transceivers may operate according to different communication protocols.

Processor 1314 can process communications being received and transmitted by base station 1310 via transceiver 1312 and in cooperation with backhaul interface 1318. The memory storage 1316 stores data and information for use by processor 1314. Memory 1316 may also be used to store computer readable instructions for execution by the processor 1314. The computer-readable instructions can be used by base station 1310 to accomplish the various functions of the base station 1310. In an aspect, memory 1316, or parts thereof, may be considered a non-transitory machine-readable medium. The functionality of base station 1310 may be accomplished by processor 1314 in conjunction with the memory 1316, transceiver 1312, and backhaul interface 1318. Furthermore, in addition to executing instructions, processor 1314 may include specific purpose hardware to accomplish some or all of the functions of base station 1310.

FIG. 13B is a block diagram of a mobile station 1350 in accordance with aspects of the invention. For example, mobile station 1350 may represent mobile station MS1 shown in previous figures.

Mobile station 1350 may be capable of operating in a GSM, a WiMAX, a UMTS or an LTE wireless communication network, or other known types of wireless networks or subsequently developed types of wireless networks. In various aspects, mobile station 1350 may operate in a low earth orbit (LEO) satellite communication network, such as that shown in the previous figures. Alternatively, mobile station 1350 may be implemented in a very low earth orbit satellites (VLEO) satellite communication network, a balloon-based communication network, an airplane-based communication network or any other type of broadband communication system implementing vehicles with the equivalent of a GSM base transceiver station BTS function, a WiMAX base station function, a UMTS NodeB function, an LTE evolved NodeB (eNodeB or eNB) function or a similar function.

Mobile station 1350 includes a processor 1354, which is coupled to a transceiver (transmitter-receiver) 1352, a user interface 1358, and a memory storage 1356. The transceiver 1352 is configured to transmit and receive communications wirelessly with other devices. Mobile station 1350 generally includes one or more antennae, in connection with transceiver 1352, for transmission and reception of radio signals. The communications of the transceiver 1352 may be with base stations in satellites and also with ground stations. Transceiver 1352, in connection with antennae provided in mobile station 1350 communicate with a satellite, for example, within a communication coverage area of the satellite, such as a moving coverage area on the earth's surface as the satellite moves along its predetermined orbital path. Such a communication coverage area may be a single satellite coverage area or may consist of multiple spot beams generated by the satellite to make up the entire communication coverage area.

Processor 1354 can process communications being received and transmitted by mobile station 1350 via transceiver 1352. Memory 1356 stores data and information for use by processor 1354. Memory 1356 may also be used to store computer readable instructions for execution by processor 1354. The computer-readable instructions can be used by mobile station 1350 to accomplish the various functions of mobile station 1350. In an aspect, memory 1356, or parts thereof, may be considered a non-transitory machine-readable medium. The functionality of mobile station 1350 may be accomplished by processor 1354 in conjunction with the memory 1356, transceiver 1352, and user interface 1358. Furthermore, in addition to executing instructions, processor 1354 may include specific purpose hardware to accomplish some or all of the functions of mobile station 1350.

User interface 1358 includes modules for communicating with a user of mobile station 1350. User interface 1358, in aspects, includes a speaker and a microphone for audio communications with the user, a video screen for providing visual information, including video playback, to the user, and a keypad for accepting alphanumeric commands and data from the user. In some aspects, a touch screen may be used in place of or in combination with the keypad and the video screen to allow graphical inputs in addition to alphanumeric inputs and to display graphic pages, pictures, and playback video. User interface 1358 may have other configurations and include other functions and/or devices such as vibrators, cameras, sensors, and lights.

According to the above description and accompanying figures, a mobile station, system, methods, and techniques are provided for improved reception and playback of content, such as streaming video, at a mobile station in a broadband communication network, such as a satellite communication network. It can be appreciated by those skilled in the art that the devices, system, methods, and techniques described herein can also be used for improved reception and use of other types of content at a device such as streaming audio, data files, commands, and other information.

Those of skill will appreciate that the various method steps, illustrative logical and functional blocks, modules, units, and algorithm steps described in connection with the aspects disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system and devices. Skilled persons can implement the described functionality in varying ways for each particular system, but such implementation decisions should not be interpreted as causing a departure from the scope of the invention described herein. In addition, the grouping of functions within a unit, module, block, or step is for ease of description. Specific functions or steps can be moved from one unit, module, or block without departing from the invention.

Some or all of the various illustrative methods, algorithms, logical and functional blocks, units, steps and modules described in connection with the aspects disclosed herein, and those provided in the accompanying documents, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein, and those provided in the accompanying documents. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the aspects disclosed herein, and those provided in the accompanying documents, can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, devices, blocks, or modules that are described as coupled may be coupled via intermediary devices, blocks, or modules. Similarly, a first device may be described as transmitting data to (or receiving from) a second device wherein there are intermediary devices that couple the first and second device and also wherein the first device is unaware of the ultimate destination of the data.

The above description of the disclosed aspects, and that provided in the accompanying documents, is provided to enable any person skilled in the art to make or use the invention. Various modifications to these aspects will be readily apparent to those skilled in the art, and the generic principles described herein, and in the accompanying documents, can be applied to other aspects without departing from the spirit or scope of the invention. Thus, it is to be understood that the description and drawings presented herein, and presented in the accompanying documents, represent particular aspects of the invention and are therefore representative examples of the subject matter that is broadly contemplated by the present invention. It is further understood that the scope of the present invention fully encompasses other aspects that are, or may become, understood to those skilled in the art based on the descriptions presented herein and that the scope of the present invention is accordingly not limited by the descriptions presented herein, or by the descriptions presented in the accompanying documents.

What we claim is:

1. A mobile station provided in a satellite communication network comprised of multiple orbiting satellites, the mobile station comprising:
a communication time period estimator that estimates multiple communication time periods when the mobile station will be capable of communication with at least one satellite in the satellite communication network and that identifies one of the multiple communication time periods as a stable communication time period and another of the multiple communication time periods as an unstable communication time period;
a video segment requester that determines a number of video segments to receive during the stable communication time period, the determined number of video segments being sufficient for video playback on the mobile station during the stable communication time period and the unstable communication time period;
a transceiver that requests the determined number of video segments, and receives the determined number of video segments, during the stable communication time period from a content delivery network over a connection between the mobile station and the content delivery network via communication of the mobile station with a satellite in the satellite communication network; and
a video player that plays the received determined number of video segments over the stable communication time period and the unstable communication time period.

2. The mobile station of claim 1, wherein the communication time period estimator identifies at least one of the multiple communication time periods as an unstable communication time period based on an estimated handoff time period associated with a handoff of the mobile station from one satellite to another satellite in the satellite communication network.

3. The mobile station of claim 1, wherein the communication time period estimator identifies at least one of the multiple communication time periods as an unstable communication time period based on an estimated communication coverage gap during which the mobile station will not be in communication with any satellite in the satellite communication network.

4. The mobile station of claim 1, wherein the satellite communication network further includes multiple ground stations and wherein the communication time period estimator identifies at least one of the multiple communication time periods as an unstable communication time period based on a predicted handoff of a satellite that will be in communication with the mobile station from one of the multiple ground stations to another of the multiple ground stations.

5. The mobile station of claim 1, wherein the satellite communication network further includes multiple ground stations and wherein the communication time period estimator identifies at least one of the multiple communication time periods as an unstable communication time period based on a predicted ground station coverage gap during which a satellite that will be in communication with the mobile station is not in communication with any of the multiple ground stations.

6. The mobile station of claim 1, wherein each of the satellites in the satellite communication network can communicate with at least one other of the satellites in the satellite communication network via an inter-satellite side-link connection, and wherein the communication time period estimator identifies at least one of the multiple communication time periods as an unstable communication time period based on a predicted side-link handoff of a satellite that will be in communication with the mobile station from one satellite to another satellite.

7. The mobile station of claim 1, wherein the connection between the mobile station and the content delivery network is established only during the stable communication time period for receiving the determined number of video segments.

8. The mobile station of claim 7, wherein the determined number of video segments determines the duration of the connection between the mobile station and the content delivery network.

9. The mobile station of claim 1, wherein the video segment requester estimates an available communication bandwidth during the stable communication time period when the determined number of video segments will be received and then selects a video segment representation attribute for each of the determined number of video segments based on the available communication bandwidth.

10. The mobile station of claim 9, wherein the available communication bandwidth is estimated based on a predicted signal quality for the communication between the mobile station and the satellite during the stable communication time period.

11. The mobile station of claim 1, wherein video segment requester determines the number of video segments based on any of the methods and techniques provided in the description herein.

12. The mobile station of claim 1, further comprising:
a satellite orbit path estimator that estimates a satellite orbit path of at least one satellite that will be relatively nearest to the mobile station, and
wherein the communication time period estimator estimates the multiple communication time periods based on the satellite orbit path and a predicted mobile station path.

13. The mobile station of claim 1, wherein the mobile station receives, over a current communication with a satellite, a satellite orbit path for at least one satellite that will be relatively nearest to the mobile station and wherein the communication time period estimator estimates the multiple communication time periods based on the satellite orbit path and a predicted mobile station path.

14. A mobile station provided in a satellite communication network comprised of multiple orbiting satellites, the mobile station comprising:
a communication time period manager that receives, over a current communication between the mobile station and a satellite in the satellite communication network, multiple communication time periods when the mobile station will be capable of communication with at least one satellite in the satellite communication network, wherein one of the multiple communication time periods is identified as a stable communication time period and one other of the multiple communication time periods is identified as an unstable communication time period;
a video segment requester that determines a number of video segments to receive during the stable communication time period, the determined number of video segments being sufficient for video playback on the mobile station during the stable communication time period and the unstable communication time period;
a transceiver that requests the determined number of video segments, and receives the determined number of video segments, during the stable communication time period from a content delivery network over a connection between the mobile station and the content delivery network via communication of the mobile station with a satellite in the satellite communication network; and
a video player that plays the received determined number of video segments over the stable communication time period and the unstable communication time period.

15. A method for video playback on a mobile station provided in a satellite communication network comprised of multiple orbiting satellites, the method comprising:
estimating multiple communication time periods when the mobile station will be capable of communication with at least one satellite in the satellite communication network and identifying one of the multiple communication time periods as a stable communication time period and another of the multiple communication time periods as an unstable communication time period;
determining a number of video segments to receive during the stable communication time period, the determined number of video segments being sufficient for video playback on the mobile station during the stable communication time period and the unstable communication time period;
requesting the determined number of video segments during the stable communication time period from a content delivery network over a connection between the mobile station and the content delivery network via communication of the mobile station with a satellite in the satellite communication network;
receiving, via the connection between the mobile station and the content delivery network, the determined number of video segments; and
playing, in a video player in the mobile station, the received determined number of video segments over the stable communication time period and the unstable communication time period.

16. The method of claim 15, wherein the at least one of the multiple communication time periods is identified as an unstable communication time period based on an estimated handoff time period associated with a handoff of the mobile station from one satellite to another satellite in the satellite communication network.

17. The method of claim 15, wherein the at least one of the multiple communication time periods is identified as an unstable communication time period based on an estimated communication coverage gap during which the mobile station will not be in communication with any satellite in the satellite communication network.

18. The method of claim 15, wherein the satellite communication network further includes multiple ground stations and wherein at least one of the multiple communication time periods is identified as an unstable communication time period based on a predicted handoff of a satellite that will be in communication with the mobile station from one of the multiple ground stations to another of the multiple ground stations.

19. The method of claim 15, wherein the satellite communication network further includes multiple ground stations and wherein at least one of the multiple communication time periods is identified as an unstable communication time period based on a predicted ground station coverage gap during which a satellite that will be in communication with the mobile station is not in communication with any of the multiple ground stations.

20. The method of claim 15, wherein each of the satellites in the satellite communication network can communicate with at least one other of the satellites in the satellite communication network via an inter-satellite side-link connection, and wherein at least one of the multiple communication time periods is identified as an unstable communication time period based on a predicted side-link handoff of a satellite that will be in communication with the mobile station from one satellite to another satellite.

21. The method of claim 15, wherein the connection between the mobile station and the content delivery network is established only during the stable communication time period for receiving the determined number of video segments.

22. The method of claim 21, wherein the determined number of video segments determines the duration of the connection between the mobile station and the content delivery network.

23. The method of claim 15, further comprising estimating an available communication bandwidth during the stable communication time period when the determined number of video segments will be received and selecting a video segment representation attribute for each of the determined number of video segments based on the available communication bandwidth.

24. The method of claim 23, wherein the available communication bandwidth is estimated based on a predicted signal quality for the communication between the mobile station and the satellite during the stable communication time period.

25. The method of claim 15, wherein the number of video segments is determined based on any of the methods and techniques provided in the description herein.

26. The method of claim 15, further comprising:
estimating a satellite orbit path for each of at least one satellite that will be relatively nearest to the mobile station, and
wherein the multiple communication time periods are estimated based on the satellite orbit path for each of the at least one satellite and on a predicted mobile station path.

27. The method of claim 15, wherein the mobile station receives, over a current communication with a satellite, a satellite orbit path for each of at least one satellite that will be relatively nearest to the mobile station and wherein the multiple communication time periods are estimated based on the satellite orbit path for each of at least one satellite and a on predicted mobile station path.

28. A method for video playback on a mobile station provided in a satellite communication network comprised of multiple orbiting satellites, the method comprising:
receiving, over a current communication between the mobile station and a satellite in the satellite communication network, multiple communication time periods when the mobile station will be capable of communication with at least one satellite in the satellite communication network, wherein one of the multiple communication time periods is identified as a stable communication time period and one other of the multiple communication time periods is identified as an unstable communication time period;
determining a number of video segments to receive during the stable communication time period, the determined number of video segments being sufficient for video playback on the mobile station over the stable communication time period and the unstable communication time period;
requesting the determined number of video segments during the stable communication time period from a content delivery network over a connection between the mobile station and the content delivery network via communication of the mobile station with a satellite in the satellite communication network;
receiving the determined number of video segments during the stable communication time period from the content delivery network over the connection between the mobile station and the content delivery network; and
playing, on a video player in the mobile station, the received determined number of video segments over the stable communication time period and the unstable communication time period.
